(19) United States
(12) Patent Application Publication
(10) Pub. No.: US 2006/0070755 A1
(43) Pub. Date: Apr. 6, 2006

(54) Invisible trencher

(76) Inventors: Richard James Orleck, Newnan, GA (US); James Lee Burks, Cumming, GA (US)

Correspondence Address: RICHARD J. ORLECK, 3122 Hwy 154, NEWNAN, GA, 30265, US

(21) Appl. No.: 10/954,461

(22) Filed: Sep. 30, 2004

(51) Int. Cl. A01B 1/00

(52) U.S. Cl. 172/371

(57) ABSTRACT

The Invisible Trencher is a single unit tool made of solid steel having a thin square blade welded to the bottom of a hollow or concrete filled metal cylinder with an insulated grip over a handle made of hollow steel welded to the top of the unit. The Invisible Trencher is a hand operated device for creating a trench for multiple purposes such as burying electrical, fiberoptic cable, low voltage wiring, irrigation pipe, etc. underground. The special characteristic of the device is the ability to create a trench without a major disruption in the ground. The trench depth is determined by the amount of force used during manual operation and whether using the hollow or concrete filled unit. The area trenched can be immediately closed with minimal pressure. After closure of the trench the area is restored to a near original appearance without expensive reconditioning of the area.

### CROSS-REFERENCE TO RELATED APPLICATIONS

Inventors are not aware of any cross-references.

### STATEMENT REGARDING FEDERALLY SPONSORED RESEARCH OR DEVELOPMENT

This invention was not made under any federally sponsored research or development.

### BACKGROUND OF THE INVENTION

Laying underground cables, pipes and wires and trenches for irrigation and other landscaping projects has in modern times required that the area where the trench is needed required extensive disruption of the soil. Usually this was accomplished by the use of a power tool or manual device that disrupted the ground where the trench was created such that reconditioning of the closed trench area could be extensive and costly.

For example a trench was created moving the soil from the area where the trench was needed to a location to the side of the trench or to both sides of the trench. After completing the task the operator was required to close the trench. The soil was then pushed back into the trench and frequently the area had to be seeded and strawed or have sod put down to return the area to its near original appearance. The majority of the tools developed over recent times have been power tools or implements used in conjunction with power tools or motorized tools and vehicles to create the trench. The manual tools such as the shovel, pick and mattock resulted in a very inaccurate trench width and depth and required extensive disruption to the site where the trench was created. Where communication cables, lawn irrigation, extensive garden installation and design lighting is becoming a frequent addition to homes and businesses a tool is needed that will allow accuracy for installation.

A tool needs to be simple and safe to use while leaving the near original appearance when closing the trenched area, thereby reducing the cost of reconditioning the area after necessary trenching for underground installation.

The tool creates a trench that in most instances is invisible or near invisible on closure of the trench.

### BRIEF SUMMARY OF THE INVENTION

The invention is a single unit manual tool without movable parts. The tool is constructed of three parts made from cold rolled steel.

The bottom of the tool is a steel blade which is a twelve (12) inch square and is one-quarter (¼) inch thick. It is welded to a hollow or concrete filled steel cylinder or shaft after it is fitted into a slit made in the bottom of each side of the cylindrical shaft four and one-half (4½) inches long. The blade is notched on both outer edges at six (6) inches from the bottom of the blade as a guide for the depth required to bury low voltage wires according to the National Electrical Code. The bottom edge of the square blade is grinded to sharpen the tool to assist in piercing the ground.

The cylindrical steel shaft is thirty-two (32) inches long, one and seven/eights (1 7/8) inches in diameter and one-quarter (¼) inch in thickness. The bottom of the shaft is slit on each side to accommodate the top of the blade which fits into the shaft a length of four and one-half (4½) inches. The bottom of the shaft is flattened on each side where it is welded to the blade. When the shaft is filled with concrete it assists the operator with the additional gravitational force to pierce the ground to the needed depth for the job requiring the trench. The type of soil would indicate the need for the hollow tool (sandy soil) or the tool that is concrete filled (clay soil).

The handle is made of cylindrical hollow steel sixteen (16) inches long, one and seven/eights (1⅞ inches) in diameter and one-quarter (¼) inch thickness. The handle is welded to the top of the steel cylinder or shaft. An insulated grip surrounds the hollow steel cylinder on each side of the handle after it is welded to the shaft. Polyethylene caps are used to close each hollow end of the handle.

The weight of the tool depends on the content of the shaft. When the shaft is hollow it weighs seventeen (17) pounds and when it is filled with concrete tool weights twenty-two (22) pounds.

Prior to insulating and closing the handle the tool is painted with a primer and covered with an enamel with rust retardant properties.

The operator places the invisible trencher at the location where the wire, cable, pipe, edging or other reason a narrow, nondisruptive trench may be needed. The invisible trencher is then manually driven into the ground until it pierces the ground. The invisible trencher is then rocked back and forth until the desired depth and width is achieved. Once the item for which the trench was created has been placed in the trench, minimal pressure is needed to close the trench. By minimal pressure, an example would be tamping the open trench on both sides with a foot. After the trench is closed the ground is restored to its near original appearance and generally does not require reconditioning of the trenched area. An invisible trench is created so that reconditioning of the area after trenching is unnecessary. There is very little cost associated with creating the trench and little or no cost in closing the trench.

The invisible trencher is safe in that there are no power tools connected with the trencher that could cause injury. The weight of the invisible trencher does not create any potential for injury since the maximum weight of the concrete filled shaft is only 22 pounds. Of course proper body mechanics would still be required while operating the tool. Caution would still be required to avoid damaging any existing underground utilities.

### BRIEF DESCRIPTION OF THE DRAWINGS

FIG. 1. FRONTAL OR REAR VIEW OF THE SINGLE UNIT INVISIBLE TRENCHER

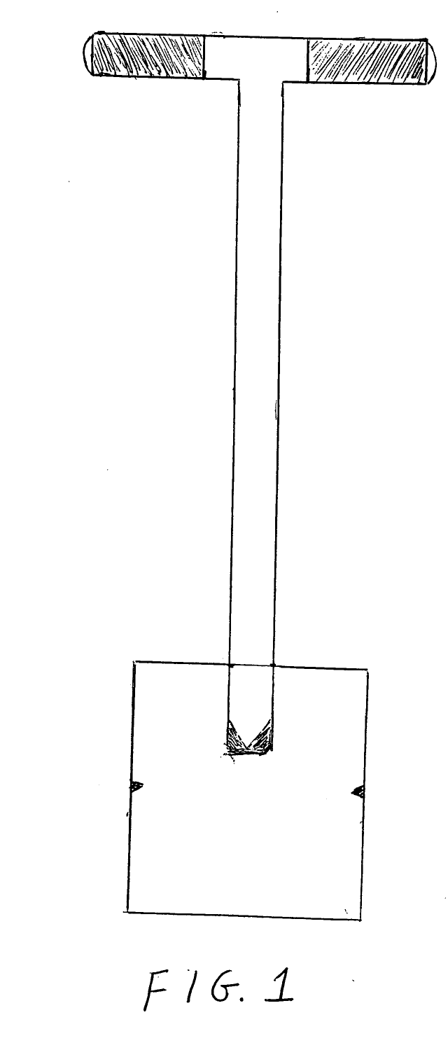

The frontal and rear view of the tool have the same appearance. The top of the tool is the handle and the bottom of the tool is the blade. The top handle and bottom blade are welded to the shaft that is either hollow or concrete filled.

FIG. 2 SIDE VIEW SHOWING ATTACHMENT OF BLADE TO SHAFT

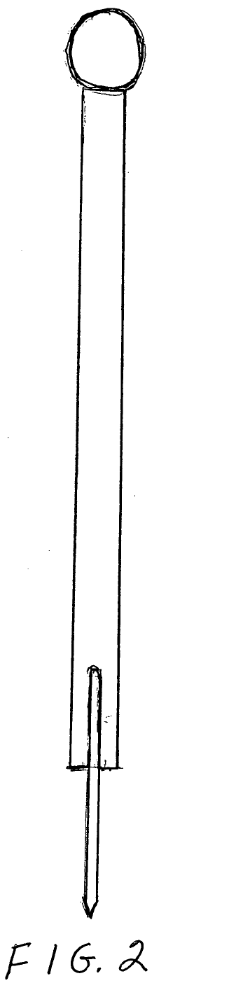

The single unit can be viewed from the side showing the one-quarter (¼) inch blade fitting into the shaft and welded the shaft and hand are cylindrical and welded at the top of the shaft to make a single unit.

FIG. 3. COMPOSITE DIAGRAM OF EACH PART.

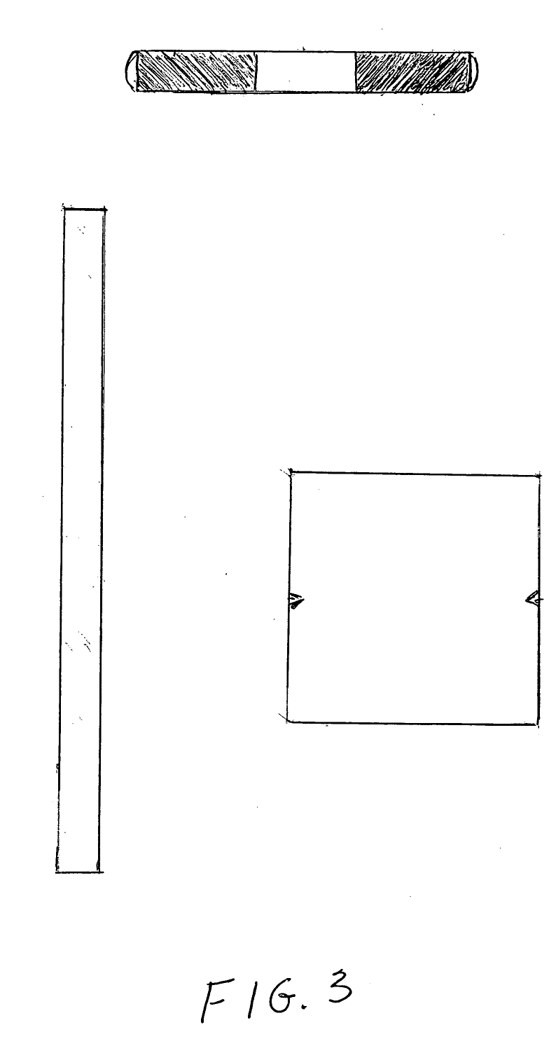

The single unit is comprised of three steel parts that are welded to form a single unit tool with no movable parts.

FIG. 4. HOLLOW OR CONCRETE FILLED Shaft

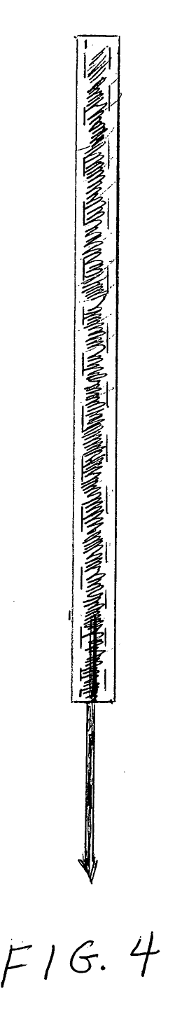

The shaft that attaches the handle at the top and the blade at the bottom is made of cold rolled steel thirty-two (32) inches in length with a diameter of one and seven/eights (1⅞) inches and a thickness of one-quarter (¼) inch. The shaft is either hollow or filled with concrete.

FIG. 5. HANDLE

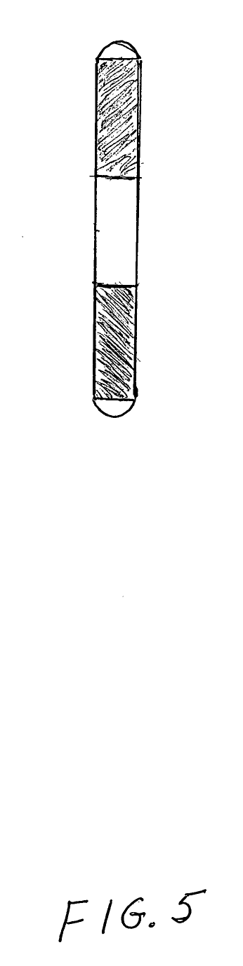

The handle is sixteen (16) inches long, one and seven/eights (1⅞) inch in diameter and one-quarter (¼) thick. After the handle is welded to the shaft, each end is closed with a polyethylene cap and each side of the hand is coated with an insulated grip.

FIG. 6. SQUARE NOTCHED STEEL BLADE

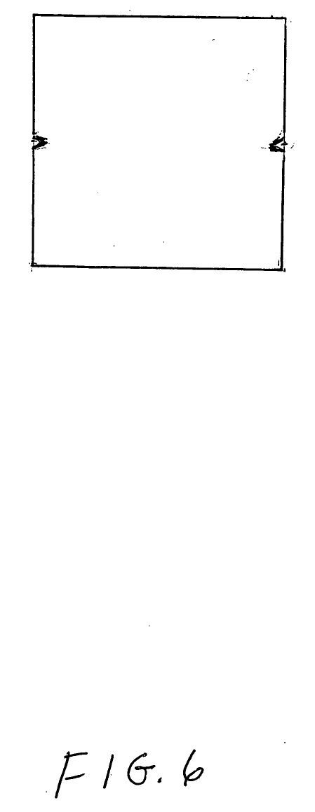

The blade is made of cold rolled one-quarter (¼) inch thick steel. The blade is a 12 inch square notched at six (6) inches on each side as a guide for the depth required to bury low-voltage wiring according to the National Electrical Code.

FIG. 7. BLADE FITS INTO SHAFT.

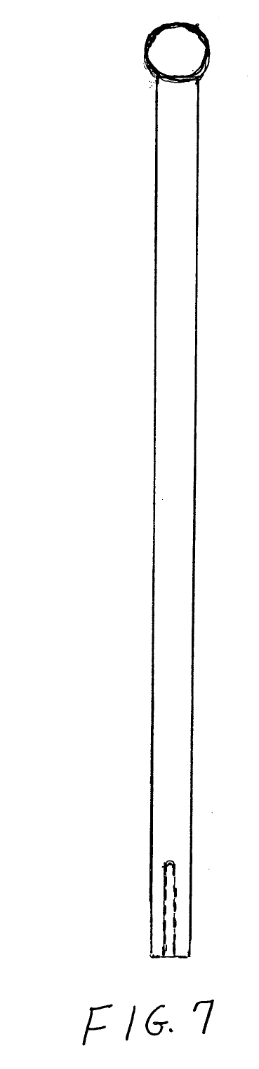

The blade slides into the bottom of the shaft to fit into a four and one-half inch slit cut into each side of the shaft. After the blade is fit into the slit the bottom of the shaft is flattened onto the blade and the two parts are welded together.

### DETAILED DESCRIPTION OF THE INVENTION

The Invisible Trencher is a single unit made of three main parts. All three parts are one-quarter (¼) inch cold rolled steel and consist of: 1) a twelve (12) inch square notched at six (6) inches comprises the blade attached to the bottom of the tool; 2) a thirty-two (32) inch long cylinder or shaft with a diameter of 1⅞ inches, which at the bottom is attached the blade and at the top a handle is attached; and 3) the handle is a sixteen (16) inch cylinder with a diameter of 1⅞ inches.

The parts are welded at the top of the shaft and at the bottom of the shaft to attach the blade and the handle.

The shaft at the bottom has a 4½ inch slit on each side so that the blade fits into the bottom of the cylinder and then the bottom ends are flattened along the flat side of the blade where the shaft attaches to the blade. A weld is then made sealing the blade to the shaft. The cylinder may or may not be filled with concrete depending on the soil type. Sandy soil would not require the gravitational force that more compact soils would require.

The bottom of the blade is sharpened using a grinder to create a sharpened tip to assist in piercing the ground.

The cylindrical handle is welded to the top of the shaft.

The entire unit is then painted with a primer before applying a rustproof enamel.

A polyethylene cap is placed in each end of the handle to close off the hollow handle. Then a plastic coating is applied to each side of the handle to assist in griping the device.

The manual operator inserts the blade at the location of the needed trench. With force the blade is used to pierce the ground. The Invisible Trencher is then rocked back and forth to the desired depth and width for the job, i.e. burying low voltage wiring; burying coaxial cable; installing landscape edging; burying irrigation pipe (not an exhaustive list).

By using the invisible trencher there is minimal disruption in the soil, unlike other tools used to create trenches that require reconditioning of the area where the trench was created. When using the invisible trencher the area that is trenched is restored to its original or near original condition. Most times the trench can be closed by exerting pressure with your body, i.e. tamping the trenched area with your foot.

We claim that our invention:

1. The Invisible Trencher is a single unit made of three parts each being made from ¼ inch cold rolled steel.
a) Two of the parts are cylindrical:
1) one cylindrical part being thirty-two (32) inches in length and one and seven/eights (1⅞) inches in diameter is used for the shaft or middle of the tool and may be hollow or concrete filled.
2) the second cylindrical part being sixteen (16) inches in length and one and seven/eights (1⅞) inches in diameter, closed on each end with polyethylene caps and coated on each outer side with an insulating material
b) the third part being a flat one-quarter (¼) inch thick square, twelve (12) inches by twelve (12) inches with the bottom edge being grinded to create a semi-sharp edge and a notch on each side at six (6) inches.

2. The Invisible Trencher is a single unit manually operated tool for creating an accurate yet nondisruptive trench.

3. The Invisible Trencher can be used to create trenches for multiple purposes where the operator wants an accurate and yet nondisruptive trench.

4. The operator of the Invisible Trencher may create the depth and width of the trench needed by rocking the tool back and forth after the tool pierces the ground.
Once the trench is created the operator can close the trench with minimal pressure and is not required to use soil or other materials to fill the trench.

5. When properly used the Invisible Trencher reduces or eliminates the cost of reconditioning the trenched when closed.
